(19) United States
(12) Patent Application Publication
(10) Pub. No.: US 2010/0060092 A1
(43) Pub. Date: Mar. 11, 2010

(54) Brushless direct current actuator

(76) Inventors: Patrick B. Blakesley, Bristol, IN (US); Ryan P. Garver, Bristol, IN (US)

Correspondence Address: Daniel J. Deneufbourg, Esq.;CTS Corporation, 171 Covington Drive, Bloomingdale, IL, 60108, US

(21) Appl. No.: 12/584,161

(22) Filed: Sep. 1, 2009

Related U.S. Application Data
(60) Provisional application No. 61/191,306, filed on Sep. 8, 2008.
(60) Provisional application No. 61/268,762, filed on Jun. 16, 2009.

(51) Int. Cl. H02K 7/116

(52) U.S. Cl. 310/83

(57) ABSTRACT

A brushless rotary actuator comprises a housing including a base defining a cavity for a motor assembly and a cover defining a cavity for a gear assembly. A circuit board assembly is seated in the housing between the motor assembly and the gear assembly. A rotor shaft extends through an aperture in the circuit board assembly and is coupled to the gear assembly. An output shaft is coupled to the gear assembly and extends through the cover. In one embodiment, a bearing and a bearing retainer are mounted on a sleeve formed in the base for retaining the rotor in the housing. In another embodiment, a rotor retention pin with a proximal head abutting against the top of the rotor and a distal threaded or barbed end extends into the sleeve of the housing for retaining the rotor in the housing.

### CROSS-REFERENCE TO RELATED APPLICATIONS

This application claims the benefit of the filing dates and disclosures of U.S. Provisional Application Ser. No. 61/191,306, filed on Sep. 8, 2008; and U.S. Provisional Application Ser. No. 61/268,762, filed on Jun. 16, 2009 which are explicitly incorporated herein by reference as are all references cited therein.

### FIELD OF THE INVENTION

The present invention relates to actuators in general and, in particular, to a rotary brushless direct current actuator.

### BACKGROUND OF THE INVENTION

An example of a prior art actuator is shown in U.S. Pat. No. 5,880,551, titled, “Polyphase Motor Particularly for Driving an Indicator Needle” which discloses a polyphase motor comprised of a stationary member excited by electric coils and a magnetized rotor. The rotor has N pairs and, more specifically, four or five pairs, of poles magnetized radially in alternating directions. The stationary member has at least two W-shaped circuits, each including an electric coil surrounding the central strut. The W-shaped circuits are arranged so that, when one of the central struts is opposite a magnetic transition, the other central strut is roughly opposite a magnetic pole. Pole shoes associated with the central struts of the two W-shaped circuits can be spaced at 120 degree angles.

### SUMMARY OF THE INVENTION

The present invention is directed to an actuator which comprises a housing including a base with a sleeve defining a bore and a top face. A motor assembly includes a rotor mounted to the sleeve in the housing. The rotor includes a sensor magnet thereon and a rotor shaft defining an interior bore. A stator is mounted in the housing, surrounds the rotor and includes stator terminals extending therefrom. A motor shaft/rotor retention pin extends through the bore of the rotor shaft and the bore of the sleeve in the base of the housing to receive the rotor in the housing and allow rotational movement of the rotor in the housing. A gear assembly which is also located in the housing is coupled to the rotor shaft. A circuit board is seated in the housing between the motor assembly and the gear assembly. The rotor shaft extends through a first opening in the circuit board into coupling relationship with the gear assembly and the stator terminals extend into the circuit board. A sensor is mounted to the circuit board in a relationship opposed and spaced from the sensor magnet. A cover is coupled to the base and an output shaft is coupled to the gear assembly and extends through the cover.

A bearing extends between the sleeve and the rotor. The bearing defines a bore and includes a body and a collar. The motor shaft extends through the bore in the bearing.

In one embodiment, the body of the bearing extends into the bore of the sleeve and the collar is located opposite the top face of the sleeve. In this embodiment, the actuator further comprises a bearing retainer including a ring and a plurality of downwardly extending, spaced-apart legs. In this embodiment, the sleeve defines a slot, the ring of the bearing retainer sits against the top face of the sleeve, and the legs of the bearing retainer extend into the slot for retaining the bearing and the rotor in the housing.

In another embodiment, the rotor includes an interior shoulder and a cap portion defines an interior cavity. The body of the bearing extends into the cavity of the cap portion of the rotor and the collar of the bearing abuts against the shoulder of the rotor and is located opposite the top face of the sleeve of the base of the housing. In this embodiment, the motor shaft or pin includes a proximal head abutted against the top of the rotor shaft and a distal threaded end extends into, and is secured to, the bore of the sleeve for retaining the rotor in the housing.

In another embodiment, the motor shaft includes a proximal head abutted against the top of the rotor shaft and a distal barbed end extends into, and is secured to, the bore of the sleeve for retaining the rotor in the housing.

In one embodiment, the housing includes a base defining at least a portion of the interior cavity, the base has an interior peripheral shoulder, and the circuit board includes a peripheral edge which abuts against the interior shoulder of the base when the circuit board is seated in the housing.

In one embodiment, a cover is mounted over the base, the base includes a peripheral exterior groove, and the cover defines a peripheral tongue which fits into the groove in the base for coupling the cover over the base.

Other advantages and features of the present invention will be more readily apparent from the following detailed description of the preferred embodiment of the invention, the accompanying drawings, and the appended claims.

### BRIEF DESCRIPTION OF THE DRAWINGS

These and other features of the invention can best be understood by the following description of the accompanying FIGURES:

FIG. 1 is a top perspective view of an actuator in accordance with the present invention;

FIG. 2 is a bottom perspective view of the actuator of FIG. 1;

FIG. 3 is an exploded perspective view of the actuator of FIG. 1;

FIG. 4 is a vertical cross-sectional view of the actuator of the present invention taken along the line 4-4 in FIG. 2;

FIG. 5 is an enlarged, broken vertical cross-sectional view of another embodiment of the rotor assembly of the actuator shown in FIG. 1; and

FIG. 6 is an enlarged, broken vertical cross-sectional view of a further embodiment of the rotor assembly of the actuator shown in FIG. 1.

### DETAILED DESCRIPTION OF THE EMBODIMENTS

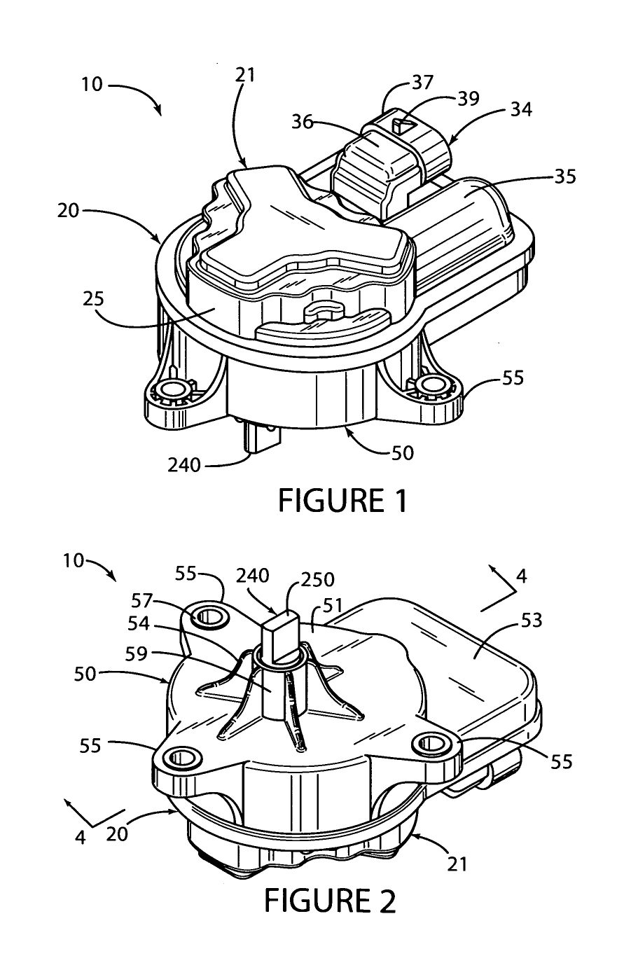

FIGS. 1-4 depict one embodiment of a compact brushless direct current (BLDC) rotary actuator 10 in accordance with the present invention. Actuator 10 comprises a housing 20, a motor assembly 98, a sensor assembly 180, and a gear assembly 220. Actuator 10 can be used in a wide variety of applications including moving valves, switches, indicators and any other application where the precise control of rotary motion is required.

Housing 20 has two separate, couplable portions: a motor assembly housing portion 21 and a gear housing portion or cover 50.

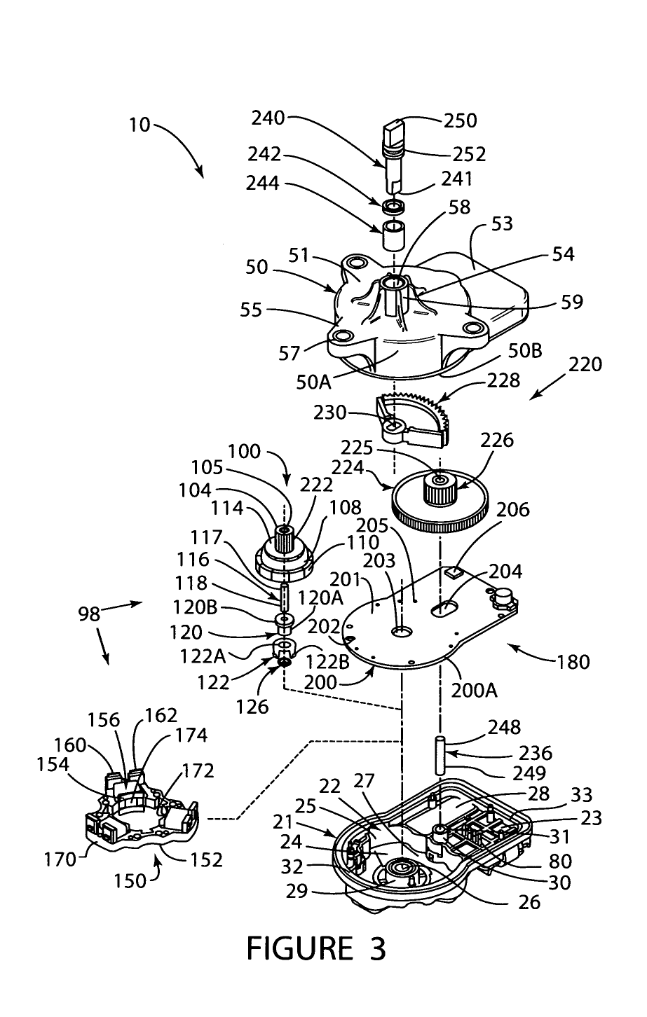

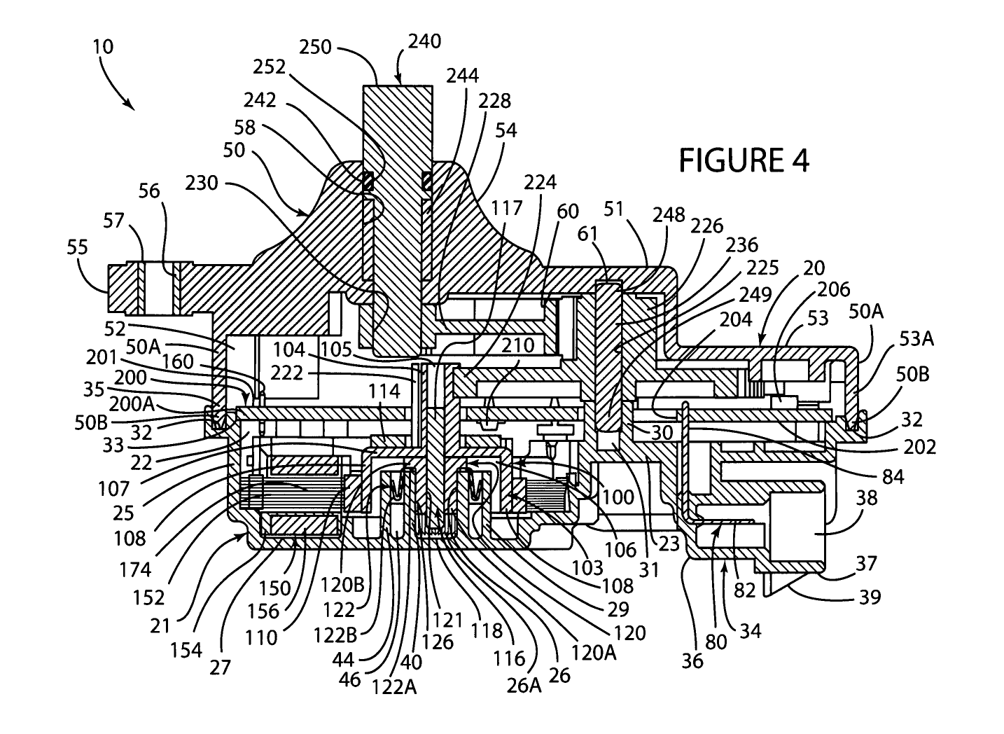

Motor housing portion 21 includes a generally vertical peripheral, circumferential side wall 25 and a generally horizontal surface or base 27 together defining a cavity 22 (FIGS. 3 and 4). A generally cylindrical sleeve or collar 29 (FIGS. 3 and 4) extends generally normally outwardly and upwardly from the base 27 into the space defined by cavity 22. Sleeve 29 defines a central cylindrical interior bore 26 (FIGS. 3 and 4). A lower portion of the inner surface of sleeve 29 defining bore 26 includes a plurality of vertically oriented ribs 26A (FIG. 4) extending around the circumference of the inner surface in spaced apart and parallel relationship. Sleeve 29 includes an annular outer wall 44 (FIG. 4) and an annular inner wall 40 (FIG. 4) spaced from outer wall 44. The space between the respective walls defines an annular circumferential slot 46 (FIG. 4).

The motor assembly housing portion 21 additionally defines a terminal platform 23 (FIGS. 3 and 4) adjacent the cavity 22; unitary with and generally co-planar with the top of the wall 25; and spaced from and parallel to the base 27. Another cylindrical sleeve or collar 30 (FIG. 3) extends outwardly and upwardly from platform 23 and defines a central, cylindrical interior bore 31 (FIG. 3). In the embodiment shown, sleeves 29 and 30 are positioned in a spaced-apart, adjacent, and co-linear relationship. A cylindrical slot 28 (FIG. 3) is defined in a portion of platform 23. A peripheral, circumferentially extending U-shaped interior rim or lip or groove 32 (FIGS. 3 and 4) is formed at the top of side wall 25 of motor housing portion 21. A peripheral, circumferentially extending interior shoulder 33 (FIGS. 3 and 4) is also formed at the top of side wall 25 of motor housing portion 21 adjacent and spaced from the groove 32.

A connector/terminal flange or shroud 34 (FIGS. 1 and 4) extends outwardly from and unitary with the outside surface of the platform 23 of housing portion 21. Connector flange 34 has a curved portion 36 extending outwardly from the outer surface of platform 23, an oval-shaped end portion 37, a hollow interior cavity 38 (FIG. 4), and a triangularly-shaped post 39. A plurality of generally L-shaped, elongated metal connector terminals 80 (FIG. 4) are mounted in cavity 38, extend through platform 23, and protrude into the interior of housing portion 21. Each terminal 80 defines a generally horizontal elongate end or portion 82 (FIG. 4) and a generally vertical elongate end or portion 84 (FIG. 4). Terminal end 82 is located in connector cavity 38 and terminal end 84 extends through platform 23, and protrude into the interior of housing portion 21. A wire harness (not shown) is adapted to be mated with connector flange 34 and terminals 80 to provide power, ground and control signals to actuator 10. A tab (not shown) on the wire harness (not shown) is adapted for retention by post 39 for securing the wire harness (not shown) to the connector flange 34.

Gear housing portion or cover 50 has a raised, generally circular portion 51 (FIGS. 2 and 4) which overlies the cavity 22 in motor housing 21 and a generally rectangular portion 53 (FIGS. 2 AND 4) which overlies the platform 23 of motor housing 21 and is unitary with, but offset from, the circular portion 53. Cover 50 and, more specifically, the two portions 51 and 53 thereof, together with a peripheral, circumferentially extending vertical wall 50A define an interior gear cavity 52 (FIG. 4). The wall 50A additionally defines a peripheral distal edge or tongue 50B which fits into the groove 32 defined in the top peripheral edge of the vertical wall 25 of motor housing portion 21 when the motor housing 21 and cover 50 are coupled together. Circular portion 51 includes an interior surface or ceiling 60 which additionally defines an interior groove or recess 61 (FIG. 4). A flange or collar 59 (FIGS. 2 and 3) extends generally normally outwardly and upwardly away from the outer surface of raised circular portion 51 and defines a cylindrical through-hole 58 (FIGS. 3 and 4) extending therethrough into communication with interior cavity 52.

A plurality of generally triangularly-shaped support ribs 54 (FIGS. 2 and 4) extend generally centrally normally outwardly and upwardly away from the outer surface of the raised circular portion 51 and extend around the outer surface of collar 59 in spaced-apart relationship. Three spaced-apart mounting arms 55 (FIGS. 2 and 4) extend radially outwardly from the peripheral edge of cover 50 and, more specifically, from the peripheral edge of circular portion 51 thereof. Each mounting arm 55 defines a distal aperture 56 adapted to receive a pressed-in metal insert 57 (FIGS. 2 and 4). A fastener (not shown), such as a screw or bolt, is adapted to pass through aperture 56 and be threaded into mating threads (not shown) on an object to which brushless direct current rotary actuator 10 is attached such as, for example, a frame, a chassis, a bracket, an engine, or a manifold.

Actuator 10 further comprises a motor assembly 98 which generally includes a rotor assembly 100 (FIGS. 3 and 4) and a stator assembly 150 (FIGS. 3 and 4).

Rotor assembly 100, which is located and seated in cavity 22 of motor housing 21 includes a circular base or skirt portion 103 (FIG. 4) and a cylindrical pinion or post or shaft 104 (FIGS. 3 and 4) unitary with the skirt portion 103. Skirt 103 is defined by a generally vertical circumferential wall 108 (FIG. 4) and a generally horizontal top radial circumferential wall or shoulder 107 (FIG. 4) which is unitary with the top of the wall 108. Shoulder 107 and wall 108 together define an interior skirt cavity 106 (FIG. 4). In the embodiment shown, skirt 103 surrounds the sleeve 29 and, more specifically, the sleeve 29 protrudes into the cavity 106 defined by skirt portion 103. Post or shaft 104 extends unitarily normally centrally upwardly from the shoulder 107; defines a cylindrical through-bore 105 (FIGS. 3 and 4); and includes a plurality of exterior gear teeth 222. A circular motor magnet 110 (FIGS. 3 and 4) extends around a lower peripheral outside edge of wall 108 of skirt 103 and is magnetized in sections of alternating polarity north and south. A circular, flat, generally doughnut-shaped sensor magnet 114 (FIGS. 3 and 4) is seated on the top of wall 107 of skirt 103; surrounds the post 104; and is magnetized in sections of alternating polarity north and south. Magnets 110 and 114 may be formed from Neodymium Iron Boron and magnetized using an appropriate magnetizer.

A steel motor shaft or pin 116 (FIGS. 3 and 4) defines opposed ends 117 and 118. End 117 is press-fit into the bore 105 of post 104 of rotor 100. End 118 of motor shaft 116 extends into the bore 26 of sleeve 29 and, more specifically, into the bore of motor bearing 120 (FIGS. 3 and 4).

Motor bearing 120 includes a hollow, elongate, cylindrical body 120A (FIGS. 3 and 4); a unitary, distal, radially outwardly projecting collar or head 120B; and defines a central through-bore 121 (FIGS. 3 and 4). Motor bearing 120 is retained in the sleeve 29 by a bearing retainer 122 (FIGS. 3 and 4). Bearing retainer 122 has a ring portion 122A defining a central through-aperture and a plurality of spaced-apart and circumferentially extending hook shaped prongs or legs 122B depending downwardly from ring portion 122A. The legs 122B of bearing retainer 122 are press-fit into the slot 46 of sleeve 29 and ring portion 122A is seated against the top peripheral edge of sleeve 29. Body 120A of bearing 120 extends through the central aperture defined in the ring portion 122A of bearing retainer 122 and into the central bore 26 defined by sleeve 29. Collar 120B of bearing 120 is seated against the top of the ring 122A of bearing retainer 122. End 118 of motor shaft or pin 116 is held in bore 26 of sleeve 29 by a shaft retainer 126 (FIGS. 3 and 4). Ribs 26A on the interior surface of bore 26 of sleeve 29 are partially deformed when shaft retainer 126 is press-fit into bore 26 to hold shaft retainer 126.

In accordance with the present invention, bearing retainer 122 advantageously allows bearing alignment to be maintained between adjoining parts made of different materials such as, for example, a metal motor bearing 120 on the one hand and a plastic motor housing 21 and sleeve 29 on the other hand. Bearing retainer 122 also advantageously allows the control of the position of motor bearing 120 in bore 26 of sleeve 29.

Stator assembly 150 (FIGS. 3 and 4) is also mounted in cavity 22 of motor housing 21 in a relationship surrounding and spaced from rotor assembly 100. Stator assembly 150 includes several steel laminations 152, bobbins 154, and windings 156. Laminations 152 are generally circular in shape. Each lamination 152 has three extensions 170; defines a central aperture 172; and three columns 174 that face the interior aperture 172. Five to twenty laminations can be stacked to form the stator assembly 150. Rotor assembly 100 extends through aperture 172. A copper wire winding 156 is wound on each of the plastic bobbins 154. Bobbins 154 are mounted to laminations 152 over column 174. Each wire winding 156 defines ends that are electrically connected to stator terminals 160 and 162. By regulating or commutating the direction of current passing through the wire windings 156, each column 174 can become a north or south electro-magnet.

Further specific details on the construction and operation of rotor assembly 100 and stator assembly 150 are disclosed in one or more of the following U.S. patents and patent publications, the description of which is incorporated herein by reference:

U.S. Pat. No. 5,880,551, titled, “Polyphase Motor Particularly for Driving an Indicator Needle”; U.S. Pat. No. 7,304,450, titled, “Motor-Reduction Unit Switched on an Absolute Position Signal”; and U.S. Pat. No. 7,466,092, titled, “Polyphase Motor”, the entire contents of which are herein incorporated by reference.

Sensor assembly 180 (FIG. 3) comprises the sensor magnet 114 (FIG. 4) coupled to rotor 100 and several magnetic field sensors such as Hall effect sensor 210 (FIG. 4) which has been mounted to the bottom surface 202 of a generally flat printed circuit board 200 (FIGS. 3 and 4). Printed circuit board 200 defines a peripheral circumferential edge 200A (FIGS. 3 and 4) which follows the contour of, and is seated on, the interior shoulder 33 of motor housing 21. Circuit board 200 covers and overlies motor housing cavity 22 and the platform 23 and thus respective rotor and stator assemblies 100 and 150 seated in cavity 22. Circuit board 200 has a top side or surface 201 (FIG. 3); a bottom side or surface 202 (FIG. 4); first and second spaced-apart, co-linear apertures 203 and 204 (FIG. 3); and a plurality of plated through-holes 205 (FIG. 3).

In the embodiment shown, the post 104 of the rotor 100 extends through board aperture 203 and into the cavity 52 defined by cover 50. The sleeve 30 and a gear shaft 236 (FIGS. 3 and 4) extend through board aperture 204 and into the cavity 52 defined by the cover 50.

Although not shown in any detail, it is understood that a plurality of passive and active electronic components including a processor or controller are mounted on the opposed surfaces 201 and 202 of circuit board 200. Component 206 depicted in FIG. 3 is representative of such components. At least one Hall effect sensor 210 is mounted on bottom surface 202 in a spaced and opposed relationship to sensor magnet 114. Hall effect sensor 210 senses the magnetic field generated by sensor magnet 114. Stator terminals 160 and 162 (FIGS. 3 and 4) extend outwardly and upwardly from stator assembly 150 and are inserted into and press-fitted through selected ones of the plated through-holes 205 in board 200 which overlies the stator assembly 150. Connector terminals 80 in motor housing 21 (FIGS. 3 and 4) and, more specifically, on platform 23 thereof, are inserted into and extend through selected other ones of plated through-holes 205 in board 200 and soldered in place.

Gear assembly 220 (FIG. 3) is located in the actuator 10 above the circuit board 200 and, more specifically, in the cavity 52 defined by cover 50. Gear assembly 220 includes gear 222 surrounding rotor pinion or shaft 104 and the following stacked gears: intermediate full gear 224, full pinion gear 226, and partial output gear 228 (FIGS. 3 and 4). Motor gear 222, intermediate gear 224, pinion gear 226, and output gear 228 can be formed from plastic.

As earlier described, gear 222 surrounds the upper end of the post or shaft 104 of rotor 100. Gear 222 is coupled to and drives intermediate gear 224 which is positioned adjacent and generally co-planar with motor gear 222. Pinion gear 226 is located generally centrally above and coupled to intermediate gear 224. Pinion gear 226 drives output gear 228 which is positioned adjacent and generally co-planar with pinion gear 226 and is stacked above intermediate gear 224. Intermediate gear 224 and pinion gear 226 together define a common central aperture 225. A metal intermediate gear shaft 236 (FIGS. 3 and 4) defines opposed ends 248 and 249 and extends through the aperture 204 in board 200 and the aperture 225 (FIG. 3) in gears 224 and 226. End 248 is press-fit into the bore 61 defined in the interior surface of cover 50 and end 249 is press-fit into the collar 30 formed on the platform 23 of motor housing 21 such that intermediate gear 224 and pinion gear 226 rotate on intermediate gear shaft 236. In the embodiment shown, intermediate gear shaft 236 is spaced from and parallel to the rotor 100.

Output gear 228 (FIGS. 3 and 4) defines a central, generally rectangularly-shaped through opening 230 (FIGS. 3 and 4) that accepts the rectangular end 241 of an output shaft 240 (FIGS. 3 and 4) which extends through the aperture 58 in cover 50. Output shaft 240 has rectangularly-shaped opposed ends 241 and 250. An output shaft bearing 244 is press-fit into the aperture 58 of cover 50 (FIG. 3). Output shaft bearing 244 supports output shaft 240 for rotary movement. Output shaft 240 defines a circumferentially extending groove 252 adapted to receive a rubber o-ring seal 242 (FIGS. 3 and 4). Seal 242 seals the region between output shaft 240 and the interior cylindrical wall of collar 59 defining through-hole 58. End 250 can be coupled to an object that is desired to be accurately or precisely moved such as, for example, a valve.

In the embodiment of the actuator 10 shown in FIGS. 1-4, output shaft 240 is located in a relationship generally overlying motor assembly 98 and circuit board 200, and in a relationship spaced from and parallel to both the shaft 104 of rotor 100 and intermediate gear shaft 236.

During operation, Hall effect sensor 210 senses the magnetic field generated by sensor magnet 114 (FIGS. 3 and 4) and provides a signal representative of the position of rotor assembly 100 to processor 206 (FIG. 3). Processor 206 regulates, commutates, or switches the direction of current passing through the wire windings 156 such that each column 174 is switched at the right time to become a north or south electro-magnet thereby attracting or repelling motor magnet 100 causing rotor assembly 100 to rotate. The rotation of rotor assembly 100 drives motor gear 222 which drives intermediate gear 224 and pinion gear 226 which drives output gear 228 and output shaft 240. Processor 206 can thereby accurately determine and control the rotary position of output shaft 240.

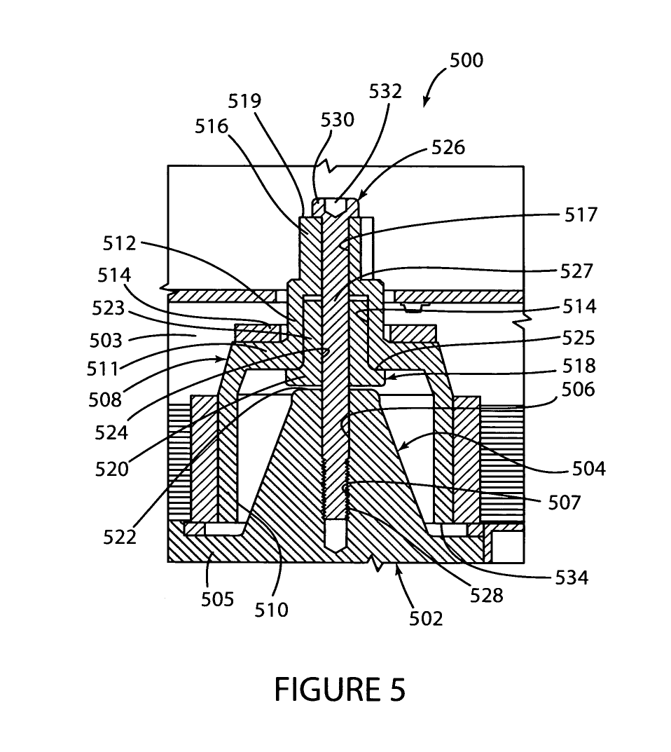

FIG. 5 depicts another motor assembly embodiment 500 and, more specifically, an alternate rotor embodiment 508 which can be used in actuator 10 in lieu of the motor assembly 98 and rotor 100 shown in FIGS. 1-4 and described above.

Motor assembly 500, in a manner similar to earlier described motor assembly 98, is adapted to be located and mounted in a housing 502, similar to housing 21, which defines an interior cavity 503; a base or floor 505; and an interior solid, generally cone-shaped sleeve 504 extending outwardly from the base 505 and including an interior cylindrical surface defining an elongate, generally vertical interior bore 506 and including, in one embodiment, a plurality or series of interior threads 507.

Motor assembly 500 additionally comprises a rotor 508 which is located and mounted for rotational movement within the interior of housing 502. Rotor 508 includes a generally cylindrically-shaped open skirt portion 510 which surrounds sleeve 504; a circumferentially extending shoulder 511 which extends unitarily generally horizontally inwardly from the top of skirt portion 510; and a generally cylindrically-shaped cap portion 512 extending unitarily upwardly from cap portion 512. Cap portion 512 defines an interior open cavity 514. Rotor 508 additionally defines an elongate, generally cylindrical pinion or shaft 516 extending unitarily generally vertically upwardly from the cap portion 512. Pinion 516 defines an elongate interior through-bore 517 extending between a top face 519 of the pinion 516 and the interior of cap portion 512.

Motor assembly 500 further comprises a rotor bearing 518 which is also located in the interior of motor housing 502. Specifically, bearing 518 includes a cylindrical collar or head 520 and a cylindrical body 523 which is unitary with the head 520. Body 523 extends into the interior cavity 514 defined by the cap portion 512 of rotor 508 and head 520 is located opposite and parallel to the top face 522 of sleeve 504. Head 520 has a diameter greater than the diameter of body 523 and thus bearing 518 defines a circumferential shoulder 525 between the head 520 and body 523. Bearing 518 additionally defines a central elongate, generally vertical interior through-bore 524 extending centrally through body 523 and head 520.

Motor assembly 500 still further comprises an elongate rotor retention shaft or pin 526 including an elongate, generally cylindrical body 527 having a threaded lower exterior surface or end 528 and an upper end including an enlarged head 530 having a diameter greater than the body 527. Head 530 defines an interior top recess or key 532 adapted to receive the head of a tool (not shown) for turning and tightening pin 526 in sleeve 504.

In accordance with the present invention, rotor 508 is located and retained in housing 502 as described in more detail below. Initially, rotor bearing 518 is located in rotor 508 in a relationship wherein bearing body 523 is fitted in rotor cavity 514 and bearing interior shoulder 525 is abutted against the interior surface of rotor shoulder 511. Rotor 508 is then positioned in motor housing 502 in a relationship wherein rotor skirt portion 510 surrounds sleeve 504; skirt portion end face 534 is positioned adjacent and spaced from an interior face of the base 505 of housing 502; and the head 520 of bearing 518 and, more specifically, the outside face thereof, is located opposite and parallel to the top outside face 522 of sleeve 504 in a relationship wherein sleeve bore 506 is in alignment with the bearing through-hole 524.

Rotor retention pin 526 is then extended successively vertically downwardly into and through the pinion through-hole 517, the bearing through-hole 524, and the housing sleeve bore 506. Pin 526 is then subsequently turned using the appropriate turning tool (not shown) to cause the mating and engagement of pin threads 528 with housing sleeve threads 507 and the movement of pin 526 further vertically downwardly into housing 502 until pin head 530 is abutted against pinion top face 522 thereby securing the pin 526 to the sleeve 504 and thus the rotor 508 in the housing 502.

It is understood that the threads 507 in housing sleeve 504 may be either pre-formed on the interior surface of housing sleeve 504 to allow for the mating of the threads 507 and 528 as discussed above or, alternatively, that the pin 526 and base 504 may be made of materials suitable to allow the pin 526 to be self-threaded into base 504, i.e., where the threads 507 in sleeve 504 are formed as the pin 526 is turned and threads 528 thereon mesh and engage with the material of the interior surface of sleeve 504.

Thus, as shown in FIG. 5, the head 530 of pin 526 provides a rotor bearing surface, a rotor radial support, and a rotor axial position control and retention abutment. Pin 526 with threads 528 is particularly suited for use in motor assemblies in which at least the sleeve 504 of housing 502 is made of metal.

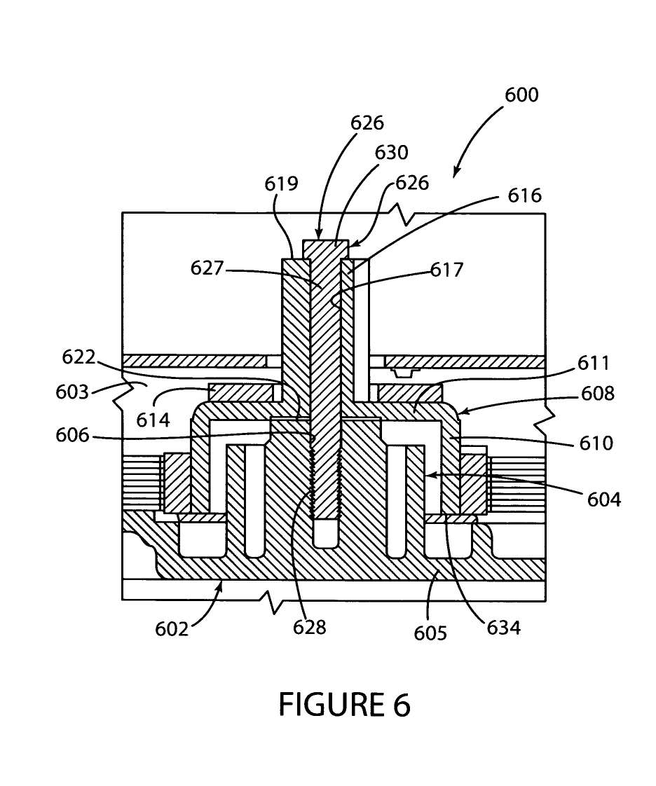

FIG. 6 shows another pin embodiment 626 particularly suited for use in a motor assembly 600, as described in more detail below, where at least the sleeve 604 of motor assembly housing 602 is made of plastic.

More particularly, FIG. 6 depicts a motor assembly 600 and, more particularly, an alternate rotor embodiment 608 which again is adapted for use in actuator 10 in lieu of motor assembly 98 and, more specifically, in lieu of rotor 100 and is adapted to be located and mounted in a housing 602, similar to housing 21 of actuator 10 and thus includes an interior, generally cylindrical sleeve 604, which is identical in structure to sleeve 28 of housing 21, and extends generally vertically upwardly and outwardly from a floor or base 605 of housing 602. Sleeve 604 includes an interior cylindrical surface which defines an elongate, generally vertical interior bore 606.

Motor assembly 600 additionally comprises a rotor 608 which is located and mounted for rotational movement within the interior of housing 602. Rotor 608 includes a generally cylindrically-shaped lower cylindrical open skirt portion 610 which surrounds the housing sleeve 604; a circumferential shoulder 611 extending generally unitarily horizontally inwardly from the top of the skirt portion 610; and an elongate, generally cylindrical pinion or shaft 616 extending generally unitarily vertically upwardly from the center of shoulder 611. Pinion 616 includes an interior cylindrical surface which defines an elongate interior through-bore 617 extending between a top face 619 of the pinion 616 and the interior of the rotor skirt portion 612.

Motor assembly 600 still further comprises an elongate rotor retention shaft or pin 626 including an elongate cylindrical body 627 with an outer surface having a series of exterior circumferential barbs 228 formed on a lower end thereof and a pin head 630 formed at the top end thereof which has a diameter greater than the body 627.

In accordance with the present invention, rotor 608 is located and retained in housing 602 as described in more detail below. Initially, rotor 608 is located in motor housing 602 in a relationship wherein rotor skirt portion 610 surrounds sleeve 604, skirt portion end face 634 is adjacent and spaced from an interior face of the floor 605 of housing 602, and the interior surface of the rotor shoulder 611 is located opposite and spaced from the top face 622 of sleeve 604 in a relationship wherein the sleeve bore 606 is in alignment with the pinion through-bore 617.

Rotor retention shaft or pin 626 is then extended and inserted successively into and through the rotor pinion through-hole 617, the interior of rotor skirt portion 610 and the housing sleeve bore 606 until the head 630 is abutted against the top face 619 of rotor pinion 616. Insertion of pin 626 into rotor 608 and housing 602 can be accomplished by ultrasonics with pressure or, alternatively, by heating the pin 626 prior to insertion into rotor 608 and housing 602. The barbs 628 are adapted and shaped to extend, grip, engage and mesh into and with the material of the interior surface defining the sleeve bore 606 to retain the pin 626 to the sleeve 604 and thus also to retain the rotor 608 in housing 602. The head 630 of pin 626, in a manner similar to the head 630 of pin 626, also provides a rotor bearing surface, a rotor radial support, and a rotor axial position control and retention abutment.

While the invention has been taught with specific reference to the embodiments described above, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An actuator comprising:
a housing including a base having a sleeve defining a bore and a top face;
a motor assembly including:
a rotor mounted to the sleeve in the housing, the rotor including a sensor magnet thereon and a rotor shaft defining an interior bore;
a stator mounted in the housing, the stator surrounding the rotor and including stator terminals extending therefrom;
a motor shaft extending through the bore of the rotor shaft and the bore of the sleeve in the base of the housing for allowing rotational movement of the rotor in the housing;
a gear assembly located in the housing and coupled to the rotor shaft;
a circuit board seated in the housing between the motor assembly and the gear assembly, the rotor shaft extending through a first opening in the circuit board into coupling relationship with the gear assembly and the stator terminals extending into the circuit board;
a sensor mounted to the circuit board in a relationship opposed and spaced from the sensor magnet;
a cover coupled to the base; and
an output shaft coupled to the gear assembly and extending through the cover.

2. The actuator according to claim 1, further comprising a bearing between the sleeve and the rotor, the bearing defining a bore and including a body and a collar, the motor shaft extending through the bore in the bearing.

3. The actuator according to claim 2, wherein the body of the bearing extends into the bore of the sleeve and the collar is located opposite the top face of the sleeve, the actuator further comprising a bearing retainer including a ring and a plurality of downwardly extending, spaced-apart legs, the sleeve defining a slot, the ring of the bearing retainer sitting against the top face of the sleeve, and the legs of the bearing retainer extending into the slot for retaining the bearing and the rotor in the housing.

4. The actuator according to claim 2, wherein the rotor includes an interior shoulder and a cap portion defining an interior cavity, the body of the bearing extending into the cavity of the cap portion of the rotor and the collar of the bearing abutting against the shoulder of the rotor and located opposite the top face of the sleeve of the base of the housing, the motor shaft including a proximal head abutting against the top of the rotor shaft and a distal threaded end extending into the bore of the sleeve for retaining the rotor in the housing.

5. The actuator of claim 1, wherein the motor shaft includes a proximal head abutting against the top of the rotor shaft and a distal barbed end extending into the bore of the sleeve for retaining the rotor in the housing.

6. An assembly comprising:
a housing defining a bore;
a rotor located in the housing, the rotor defining a through-hole; and
an elongate rotor retention pin extending through the through-hole in the rotor and the bore in the housing for retaining the rotor in the housing; and
means for retaining the pin in the housing.

7. The assembly of claim 6 wherein the bore in the housing is defined by an interior surface, the means for retaining the pin in the housing comprising a series of threads on the outer surface of the pin which engage with the interior surface of the housing.

8. The assembly of claim 7 wherein at least a portion of the surface defining the bore in the housing includes a series of threads which mate with the series of threads on the pin.

9. The assembly of claim 7 wherein the pin includes a proximal head which abuts against the top of the rotor to retain the rotor in the housing.

10. The assembly of claim 9 wherein the head of the pin defines a recess adapted to receive the head of a pin turning tool.

11. The assembly of claim 6 further comprising a sleeve in the housing including a top face and defining the bore in the housing and a slot, the assembly further comprising;
a rotor bearing defining a through-hole and including a body extending through the bore in the sleeve and a collar located opposite the top face of the sleeve; and
a bearing retainer including a ring defining a through-hole and seated against the top face of the sleeve and a plurality of legs extending into the slot in the sleeve, the body of the bearing extending through the through-hole in the ring of the bearing retainer and the collar of the bearing abutting against the ring of the bearing retainer, the pin extending through the through-hole in the rotor bearing.

12. The assembly of claim 6 wherein the bore in the housing is defined by an interior surface, the means formed on the outer surface of the pin for securing the pin in the housing comprising a series of barbs on the outer surface which grip the interior surface of the housing.

13. The assembly of claim 6, wherein the rotor includes a skirt portion, a cap portion defining an interior cavity, and an elongate pinion defining the rotor shaft, the assembly further comprising a rotor bearing fitted in the cavity of the cap portion of the rotor and defining a through-hole, the pin extending through the through-hole in the rotor bearing.

14. A compact actuator assembly comprising:
a housing including a wall defining an interior cavity;
a motor assembly located in the interior cavity of the housing, the motor assembly including a stator having stator terminals extending therefrom and a rotor having a rotor shaft and a sensor magnet associated therewith;
a circuit board assembly located in the interior cavity of the housing and including at least one sensor thereon in a relationship opposed and spaced from the sensor magnet associated with the rotor of the motor assembly, the stator terminals extending into the circuit board assembly;
a gear assembly located in the interior cavity of the housing and coupled to the shaft of the rotor; and
an output shaft including a first end coupled to the gear assembly and a second end extending through the wall of the housing.

15. The compact actuator assembly of claim 14, wherein the circuit board assembly is located in the cavity of the housing between the motor assembly and the gear assembly, the rotor shaft extending through an aperture in the circuit board assembly, the gear assembly comprising a first gear supported by a shaft in the housing cavity and coupled to the rotor shaft, the output shaft being coupled to a second gear.

16. The compact actuator assembly of claim 14, wherein the housing wall includes a sleeve extending into the interior cavity, the rotor surrounding the sleeve and a motor shaft extending into the sleeve.

17. The compact actuator assembly of claim 14 wherein the housing includes a base defining at least a portion of the interior cavity, the motor assembly being located in the base, the base having an interior peripheral shoulder and the circuit board assembly including a peripheral edge, the peripheral edge of the circuit board assembly abutting against the interior shoulder of the base.

18. The compact actuator assembly of claim 14, wherein the housing includes a base defining at least a portion of the interior cavity and a cover mounted over the base, the base including a peripheral exterior groove and the cover defining a peripheral tongue which fits into the groove in the base.
